(19) United States
(12) Patent Application Publication
(10) Pub. No.: US 2017/0085688 A1
(43) Pub. Date: Mar. 23, 2017

(54) Flexible Computing Devices

(71) Applicants: Jing Zhou, New York, NY (US); Melora Zaner, New York, NY (US); Shannon You, Shanghai (CN)

(72) Inventors: Jing Zhou, New York, NY (US); Melora Zaner, New York, NY (US); Shannon You, Shanghai (CN)

(21) Appl. No.: 15/338,040

(22) Filed: Oct. 28, 2016

Related U.S. Application Data
(63) Continuation-in-part of application No. PCT/CN2014/077553, filed on May 15, 2014.
(60) Provisional application No. 62/357,277, filed on Jun. 30, 2016.

(51) Int. Cl. H04M 1/02; H04B 5/00; H04B 1/3816; G06F 3/01; H04B 11/00; G09G 3/14; G06F 1/16; H04W 4/00; H04B 1/3818

(52) U.S. Cl. CPC H04M 1/0268; H04W 4/008; H04B 5/0062; H04M 1/0264; H04B 1/3816; H04B 1/3818; H04B 11/00; G09G 3/14; G06F 1/163; G06F 1/1635; G06F 1/1652; G06F 1/1698; G06F 1/1686; G06F 1/1694; G06F 3/011; H04B 2001/3861

(57) ABSTRACT

A device includes a housing adapted for wearing on a human body, with a sparse light-emitting array including a plurality of spaced light-emitting sources, a control circuit including a wireless module, the control circuit configured to control lighting of the sparse light-emitting array in response to external control signals that are received wirelessly; and at least one electrical contact arranged on the housing, the at least one electrical contact arranged to provide at least one of: electrical power to the smart wearable device or data transfer between the smart wearable device and an external device.

This application is a continuation-in-part of PCT Application Number PCT/CN2014/077553, entitled, “Smart wearable device having adjustable light emitting array,” filed on May 15, 2014, and published as WO 2015/172323, which is hereby incorporated by reference in its entirety. This application claims the benefit of Provisional Patent Application No. 62/357,277, entitled, “Flexible computing device,” filed on Jun. 30, 2016.

### BACKGROUND

The present application relates generally to flexible computing devices such as may be used in a smart wearable device, including smart wearable devices with adjustable light-emitting arrays and the like.

A smart bracelet is one implementation of a smart wearable device. By wearing a smart bracelet and communicating with smart phones wirelessly, users can record real-time exercise data, sleep and diet data, etc., so that the smart devices can facilitate healthy living. However, the intelligent bracelets in the prior art are designed for peoples' exercise and health needs, and their functions are focused on collecting the exercise data by the sensor to analyze the health status of the user through statistical data, such as the consumption of energy, distance of running, rhythms of steps, etc., in order to give a lot of recommendations based on the user's exercise habits and goals. Such a smart bracelet is not very useful for users who do not exercise regularly.

### SUMMARY

One example of a wearable device comprises: a housing having a physical shape and size suitable for wearing on human body, and the housing comprises a first portion for attaching to the human body and a second portion exposed to the outside of the human body; a sparse light-emitting array comprising a plurality of spaced light-emitting sources, and the light-emitting sources are arranged on the second portion and emit lighting under the control of the wearable device; a control circuit including a wireless module for controlling the light emitting of the sparse light-emitting array by external control signals in a wireless way; at least one electrical contact arranged on the housing for providing charging or data exchanging port for the smart wearable device.

In an example, the wearable device further comprises a sensor arranged inside the housing for sensing the user's body movements when the user operates the smart wearable device, so as to generate a control signal for controlling the wearable device. In an example, the sensor is an acceleration sensor or a gravity sensor. In an example, the sensor senses whether the user taps or shakes the wearable device to reach a certain of degree, which degree will be above a threshold to enable display function of the sparse light-emitting array. In an example, the light-emitting source is an LED. In an example, the sparse light-emitting array is an array of 5×15. In an example, the adjacent light-emitting sources in the sparse light-emitting array have a space in a range of 2 mm-4 mm. In an example, the shape of the light-emitting sources is circular point shaped, and the size thereof is of 0.7 mm-1.2 mm in diameter. In an example, the displaying duration, brightness and the color of each light source can be controlled independently. In an example, the smart wearable device further comprises a second sparse light emitting array which is controlled individually or jointly with the sparse light emitting array. In an example, the wireless module is at least one selected from a group of Wi-Fi wireless module, WiMAX module, WAPI module, Bluetooth module, NFC module, infrared module, ultrasonic module, Wireless USB module and RFID module. In an example, the wireless module is a Bluetooth module. In an example, the wireless module is integrated in a central controller of the control circuit. In an example, the wearable device is at least one selected from a group of bracelet, jewelry, earrings, necklace, armbands, belt, foot ring, hair band, headwear, and pet collar. In an example, the wearable device is a wearable bracelet comprising an outer layer provided with the sparse light-emitting array and an inner layer attached to the wrist of the human body, and the outer layer is of resin material. In an example, the bracelet is C-shaped with one end open or a closed ring shape. In an example, the wearable device further comprising a charging means separated from the wearable device, the charging means is for accommodating the wearable device and for charging or data exchanging. In an example, the charging means includes a base, and the base is provided with a slot for receiving the wearable device, a slot contact is provided inside the slot corresponding to the at least one electrical contact, so that the slot contact is able to contact with the electrical contact when the wearable device is disposed inside the slot so as for charging or data exchanging for the wearable device. In an example, the wearable device further comprises a power supply module for providing power supply and an interface module for charging the power module. In an example, the external control signal comes from mobile terminal interface applications, and the mobile terminal is selected from smart phones, tablets, laptops or other mobile computing devices. In an example, the user interface application is associated with at least one social network account of the user, when a particular user behavior occurs on the social network, a specific instruction will be generated to drive the light emitting of the sparse light-emitting array of the wearable device. In an example, the interface application is configured with calling reminders, SMS alerts, e-mail alerts or instant messaging alerts, which are able to generate a specific instruction to drive the light emitting of the sparse light-emitting array of the wearable device. In an example, the user is able to select colors, or select the color from a picture or photo, or select an entire picture or photo via the interface application, which are able to generate a specific instruction to drive the sparse light-emitting array of the wearable device to display corresponding colors of the light emitting. In an example, when the color selected by the user is a mixture of a plurality of colors, the mixture of a plurality of colors will be simulated to be a single color which is close to the user's intention by image mosaic algorithm, so as to drive the sparse light-emitting array of the wearable device to display corresponding colors of the light emitting. In an example, when the user selects the entire picture or photo, the sparse light-emitting arrays will be distributed in the same proportion on the selected image or photo, and then the color were extracted from the position corresponding to each of light-emitting source of the sparse light-emitting array.

A smart wearable device with adjustable sparse arrays of light-emitting lamps, according to the present application, by providing a plurality of adjustable LEDs, enable the users to wirelessly connect a bracelet to an intelligent terminal, and to adjust each light source or the entire light emitting display array by the intelligent terminal. In this way, the users can change the color of the light-emitting array and control the brightness of the light emitting arrays, etc., so that the user wearable bracelet can display personalized results. Additionally, the light-emitting array can also display status information of the intelligent terminals, such as important phone alerts, SMS tips and other functions, and to achieve the mobile location and mobile phone anti-lost functions via wireless pairing technology. Therefore, the present application greatly enriched the uses of the wearable device, made them applicable much more widely to all types of people, and provided users with a personalized choice.

An example of a flexible computing device includes: a flexible Printed Circuit Board (PCB); a flexible battery connected to the flexible PCB, the flexible battery configured to provide electrical power to the flexible PCB; a plurality of Integrated Circuit (IC) chips mounted on the flexible PCB, the plurality of IC chips including at least a controller chip, a motion sensor chip, and a communication chip; and a display connected to the flexible PCB, the display configured to be controlled by the controller chip in response to an input from at least one of the motion sensor chip and/or the communication chip.

The flexible computing device may also include a curved inner housing component that encircles or substantially encircles an opening, the flexible battery and the flexible PCB extending around the curved housing component, and the display extending around the flexible battery and the flexible PCB to form an outer housing component. The plurality of IC chips may further include a GPS receiver chip connected to the controller chip. A Subscriber Identification Module (SIM) card slot may be mounted on the flexible PCB, the SIM card slot configured to accept a SIM card identifying a user of the flexible computing device on a cellular network. The display may be an LED matrix display or an OLED display. A camera may be connected to the controller chip, the controller chip configured to control the display in response to an input from the camera. The communication chip may be: a Wi-Fi wireless chip, WiMAX chip, Bluetooth chip, NFC chip, infrared chip, ultrasonic chip, Wireless USB chip, or RFID chip. The flexible computing device may be embodied in a sporting article and comprises additional motion sensor chips disposed at different locations in the sporting article, each of the additional motion sensor chips providing input to the controller chip. The communication chip may be a NFC chip or an RFID chip that is configured for communication with an electronic payment terminal or a lock.

It should be understood that the description and the subsequent detailed description of the aforementioned generally are exemplary illustration and explanation, and should not be used for the restrictions of the claims of present application.

### BRIEF DESCRIPTION OF THE DRAWINGS

By reference to the accompanying figures, further objects, features and advantages of the present disclosure will be illustrated by the following description of embodiments of the present invention.

FIG. 1a schematically shows the structure of a smart wearable device with adjustable s according to one embodiment, which is in the form of bracelet.

FIG. 1b schematically shows a sectional view of the main part of a smart wearable device with adjustable LEDs according to one embodiment.

FIG. 1c schematically shows a charging device which is suitable for a smart wearable device with adjustable LEDs according to one embodiment.

FIG. 2 schematically shows an internal control circuit of a smart wearable device with adjustable LEDs according to one embodiment.

FIG. 3 schematically shows an exemplary graphical user interface of an application on a mobile terminal.

FIGS. 4(a)-(b) show an example of extracting the colors on pictures supplied by the user and displaying on LEDs.

FIG. 5 shows an example of a flexible computing system.

FIGS. 6(a)-(b) illustrate an example of a flexible PCB.

FIGS. 7(a)-(b) illustrate an example of a flexible battery.

FIGS. 8(a)-(b) illustrate an example of a flexible computing system embodied in a bag.

FIGS. 9(a)-(b) illustrate an example of a flexible computing system embodied in a garment.

FIGS. 10(a)-(b) illustrate an example of a flexible computing system embodied in a golf club.

FIG. 11 illustrates an example of a flexible computing system embodied in a tennis racquet.

FIG. 12 illustrates an example of a flexible computing system embodied in a baseball bat.

FIG. 13 illustrates examples of bracelets with high resolution displays.

FIG. 14 illustrates an example of an interactive kiosk.

### DETAILED DESCRIPTION OF EXEMPLARY EMBODIMENTS

By reference to exemplary embodiments, the objects and functions of the present invention and methods for achieving these objects and functions will be described. However, the present invention is not limited to the following disclosed exemplary embodiments; it can be achieved by different means. This specification is intended to help those skilled in the art to understand the relevant details of the present invention and is not intended to limit the scope in any way.

In the following, with reference to the accompanying figures, some embodiments of the present invention will be described. In the figures, the same reference numbers represent the same or similar parts, or the same or similar steps.

A smart wearable device with an adjustable sparse array of light-emitting diodes (LEDs) may enable users to wirelessly connect a bracelet to an intelligent terminal, and to adjust each light source or the entire light-emitting display using the intelligent terminal. In this way, the users can change the color of the light-emitting array and control the brightness of the light emitting array, etc., so that the user wearable bracelet can display personalized results. Additionally, the light-emitting array can also display status information from the intelligent terminals, such as important phone alerts, SMS tips and other functions, and may facilitate mobile location and mobile phone anti-lost function via wireless pairing technology.

A wearable device according to some embodiments comprises a housing designed to have a suitable physical shape and size to be worn on the body, the housing may comprise a first portion for affixing to the body and a second portion exposed to the outside. In the second portion, a sparse light-emitting array including a plurality of spaced light sources are provided, wherein the light sources are used to emit light under the control of the wearable device. A wearable device according to some embodiments further comprises a control circuit, which includes a wireless module for wirelessly receiving the external control signal, in order to control the light emission of the sparse light emitting array.

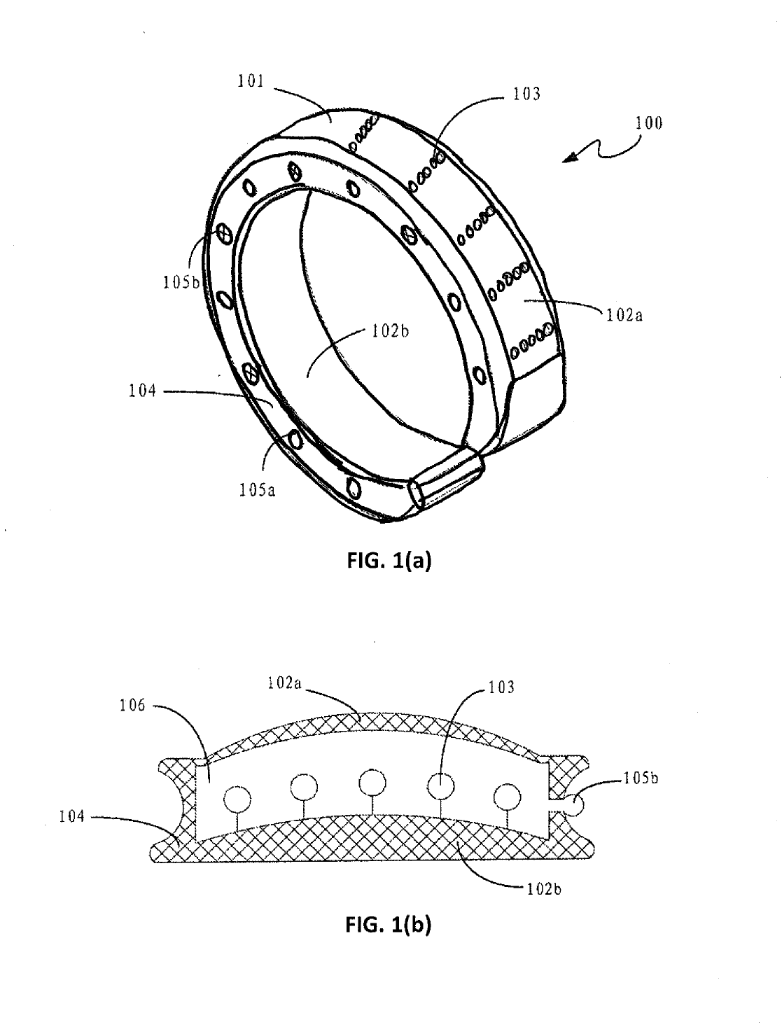

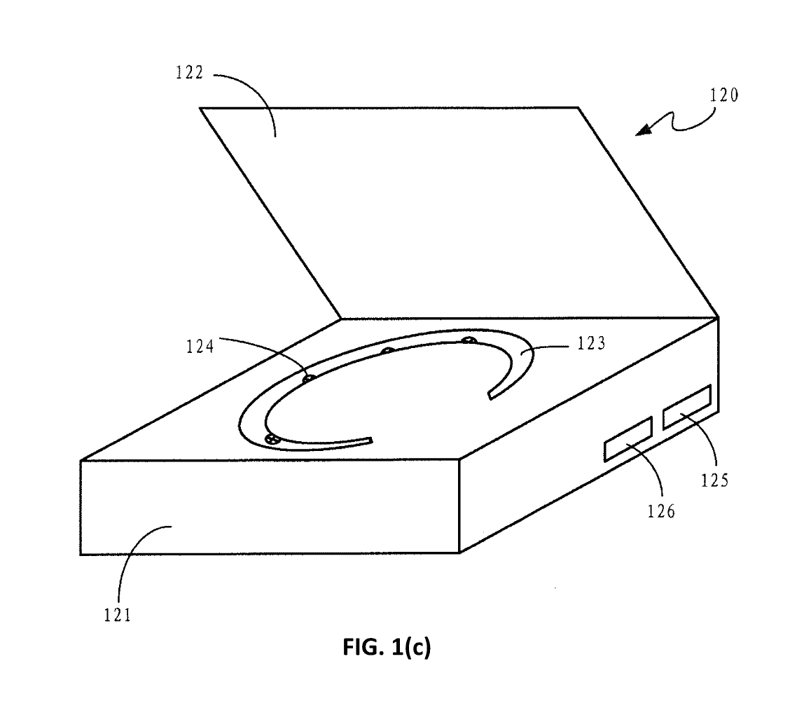

FIG. 1a schematically shows the structure of a smart wearable device 100 with adjustable light emitting array according to an embodiment. As shown in FIG. 1a, the smart wearable devices with adjustable light-emitting array are implemented as a bracelet 100. Those skilled in the art can understand that in addition to a bracelet, a wearable device according to some embodiments can also be implemented as jewelry products, such as earrings, necklace, armbands, belts, foot ring, hair bands, headwear, bag, handbag, garment such as dress, shirt, jacket, sweater, and the like, as well as pet collars and so on.

According to an embodiment shown in FIG. 1a, a wearable device may be implemented as a wristband or bracelet 100. The bracelet 100 has a housing 101; the bracelet 100 may be C-shaped with one end open or a closed ring shape. Users can wear it on the wrist so that the inner layer 102b of the bracelet 100 lies in contact with their wrist. An array consisting of a plurality of adjustable LEDs 103 is disposed on the outer surface 102a of the bracelet 100, e.g., a sparse array having a plurality of LEDs with a distance between each other. The LEDs of FIG. 1 form a sparse array such that each LED can be controlled independently, for example, all LEDs can be controlled to display the same color, or they can also be controlled to display different colors on different locations, or they can be controlled so that LED at specific locations display color and LEDs at other locations do not emit light so as to constitute a pattern. Each LED can also be controlled independently in term of the display time, brightness, and color, for example by setting alternately adjacent LED light-emitting display, it can display in the form of a ticker so that a pattern (e.g. text, symbol, or other pattern) appears to move across the display.

The LED 103 in this example is a three-color RGB-LED, with the round dot shape, and with size diameter between 0.7 mm-1.2 mm, for example, a diameter of 1 mm. Alternatively, a single LED 103 can also be square shape, with the size between 0.7 mm×0.7 mm-1.2 mm×1.2 mm, e.g. of 1 mm×1 mm. According to one embodiment, in the LED array 103, the distance between each adjacent LED 103 is equal when they are arranged on the outer layer 102a, that is, four adjacent LED form a square. The distance between each adjacent LED 103 is in the range of 2 mm-4 mm, for example, 3.7 mm. The number of LEDs 103 in an array may be 5×15 pieces (i.e. 45 LEDs total), wherein in the direction around the wrist, there are 15 LEDs, and in the perpendicular direction (along the direction of a user's arm), there are 5 LEDs. Those skilled in the art can appreciate that other numbers of LEDs may also be selected for array 103 consisting of LEDs or other light sources. When selecting the number of LEDs 103 included in the array, the factors may be considered include: energy consumption of the LEDs, the heat emitted and the fit between the internal control circuit in the form of flexible printed circuit board (FPC) and the inner layer of the bracelet 100.

The shape of bracelet 100, the amount and the arrangement of LEDs as shown in FIG. 1a is merely illustrative, and the skilled person in the art will appreciate there are a variety of arrangement can be used. Light sources may be LED light sources, but other semiconductor light sources can also be used.

According to another embodiment, another array consisting of LEDs 104 can be arranged on the side connecting the outer layer 102a and inner layer 102b of the bracelet 100. The size and shape of LEDs 104 can be the same as or different with those of LEDs 103, The LEDs 104 can be controlled connectively or independently with LEDs 103.

According to an embodiment, at least one electrical contact 105b is provided at the interface of the outer layer 102a and inner layer 102b of the bracelet 100, wherein the electrical contact 105b is connected with a charging device (will hereinafter described with reference to FIG. 1c) for example, in wireless manner, in order to charge the bracelet 100 or exchange the data. As shown in FIG. 1a, the bracelet 100 may have four electrical contacts 105b, which is distributed according to the position of another set of LEDs 105a, and may be distributed with equal distance to each other as shown in FIG. 1a. Alternatively, they are distributed on one end of the interface. According to another embodiment, considering the cost and control, the LEDs 105a may be substituted by dot decorative sheets which have the suitable shape, size and color with the electrical contact 105b.

FIG. 1b schematically shows the sectional view of the main part of the smart wearable device with adjustable LEDs as shown in FIG. 1a. As shown in FIG. 1b, a plurality of LEDs 103 are placed in the cavity 106 between the outer layer 102a and the inner layer 102b of the bracelet 100. The outer layer 102a may be made of a hard material, such as polymer material such as resin material, polypropylene resin, PE resin, or the flavor resin. The outer layer 102a may be made of polymer material transparent to light since it needs to present the light effects of LEDs 103. Alternatively, the outer layer 102a is made of resin material which has the semi-permeable membrane effects, for example, has the effect of frosted material. The shape of the outer layer 102a may be cambered shape. The inner layer 102b and the side frame between the outer layer 102a and the inner layer 102b may be made of metal material such as aluminum, copper and other materials, which may be opaque and light-weight materials.

Cavity 106 is embedded with a plurality of LEDs 103 and the driving circuit portion. FIG. 1b schematically shows an example wherein five LEDs 103 are arranged extending in cross-sectional view. Driving circuit portion may be made of a flexible printed circuit board (FPC) and placed in the internal cavity 106. According to an embodiment, electrical contacts 105b may be embedded. According to another embodiment, a set of LEDs can also be provided on the other side of the interface between the outer layer 102a and the inner layer 102b of the bracelet 100 (not shown).

FIG. 1c schematically shows a charging device which is suitable for the smart wearable device with adjustable LEDs according to an embodiment. As shown in FIG. 1c, the charging device 120 is provided in a box-like shape and structure, including the base 121 for receiving the bracelet 100. The base 121 is provided with a receiving slot 123 for receiving the bracelet 100, and the shape of the slot 123 may be matched to the shape of bracelet 100. Slot contacts 124 are provided inside the slot corresponding to the position of the electrical contacts 105b on bracelet 100, such that the slot contacts 124 can correspondingly contact the slot corresponding to the contact the electrical contacts 105b on bracelet 100 when the bracelet 100 when the will be placed in the slot 123, so as to charge the bracelet or perform the data exchange. The slot 123 may also be provided with positioning elements (not shown), which can position the bracelet 100 well to ensure the good connection between the slot contacts 124 and the electrical contacts 105b on bracelet 100.

An interface 125 is arranged on the base 121 for connecting the base 121 to an external power source or an external device (such as a smart phone), so as to charge the bracelet 100 or perform the data exchange. The base 121 can also comprise an additional charging port 126, such as a USB interface for connecting to other external charging devices.

Charging device 120 may further comprise a cover 122 for enclosing and protecting the base 121.

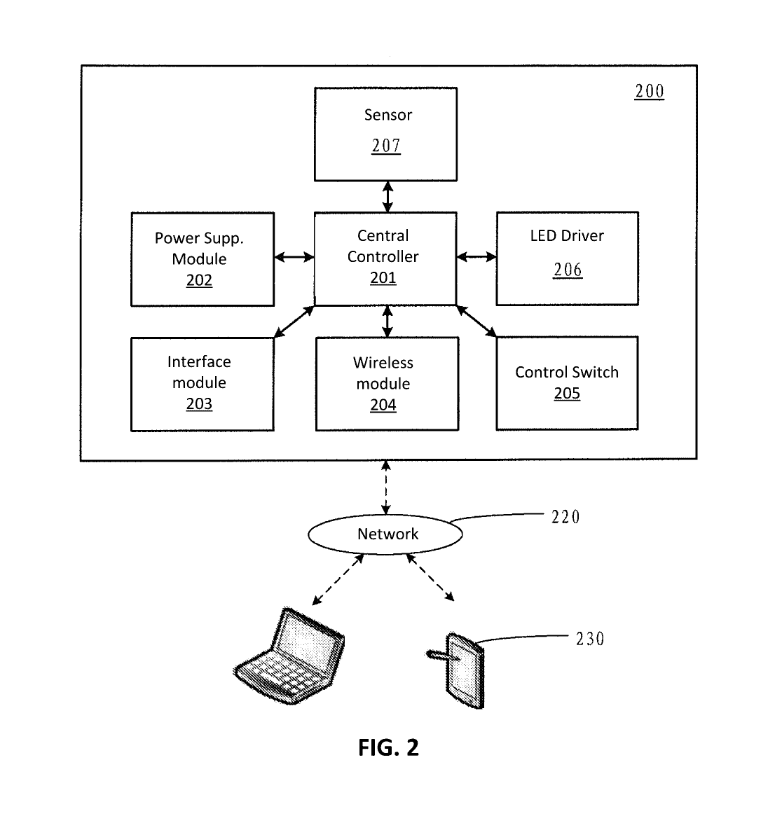

FIG. 2 schematically shows the aspects of an internal control circuit of the smart wearable device with adjustable LEDs according to one embodiment. As shown in FIG. 2, a smart wearable device 200 according to an embodiment comprises a central controller 201, a power supply module 202, an interface module 203, a wireless module 204, a control switch 205, LED driver 206 and a sensor 207.

Central controller 201, as a core component of the whole wearable device 200, controls the co-operation of other modules. Alternatively, the central controller 201 and the wireless module 204 can be separate components, or they can be integrated in one or more integrated circuits. In the case where wireless module 204 has been integrated in the central controller 201, the central controller 201 can function as wireless transmitter/receiver, and there is no additional wireless module 204. The central controller 201 may be an MTK2502 chip, integrated with wireless communication functions of Bluetooth 4.0.

Central controller 201 may receive control instructions from external mobile terminal 230 via the network 220 by the wireless module 204. The instruction for example is a controlling instruction of adjusting the LEDs. The mobile terminal 230, for example, can be a smart phone, tablet, laptop or other mobile computing device. The mobile terminal 230 comprises interface applications, such as web browser or custom application (app), for bidirectional communication with web applications. The network 220 may be at least one protocol selected from Wi-Fi, WiMAX, WAPI, Bluetooth, near field communication (NFC), infrared, ultrasonic, Wireless USB, ZigBee, RFID, etc.

The power supply module 202 may be used to supply the power for the wearable device 200 when it is working. The power supply module 202 is a built-in non-removable battery, for example, a rechargeable battery. When the power supply module 202 reaches a low-power condition it can be charged by an external power source via the interface module 203.

Interface module 203 may be, for example, a four-wire cable structure with respectively positive and negative power supply path and the data signal path. For example, a four-wire cable structure suitable for standard USB data and power transmission can be used, in which two wires are used for the transmission of data when the wearable device 200 is connected to a computer or a mobile terminal, and the other two wires are used for transmitting power signals when the wearable device 200 is connected to a charging device. According to an embodiment, the wearable device 200 may be set to be automatically triggered to power-on when it is connected to a charger or a mobile terminal through the interface module 203. According to another embodiment, the interface module 203 may be implemented as a wireless connection and connected through electrical contacts, such as the electrical contacts 105b as shown in FIG. 1a.

Wireless module 204 may achieve communications between the wearable device 200 and a mobile terminal via a wireless network. The wireless module 204 may comprise at least one module selected from: Wi-Fi wireless modules, WiMAX modules, WAPI modules, Bluetooth modules, near-field communication (NFC) modules, infrared modules, ultrasonic modules, Wireless USB modules, RFID modules, etc. The wireless module 204 may be a Bluetooth module, supporting Bluetooth 4.0 or lower version of communication protocols. Wireless module 204 may comprise a receiver and a transmitter to receive and transmit the wireless signals from the mobile terminal. The wireless module 204 can also be designed to match the communication module of mobile terminal 230. Wireless module 204 may also periodically communicate with the mobile terminal 230, that is, may receive regular heartbeat signals from the mobile terminal 230 to monitor the condition of the mobile terminal 230, for example, whether there are new calls, short messages, etc.

A control switch 205 is used to trigger the reset function of the wearable device 200. Alternatively, it can be used to trigger power-on and power-off functions, such as the power-on and power-off functions of the LED display. For example, the control switch 205 may be configured as a physical buttons on the surface of the wearable device 200, such as a pinhole reset button.

A LED driver 206 is the drive control module for the LED 103 and 105 as shown in FIG. 1a, it receives the control instructions from external mobile terminal 230 via the wireless module 204, and then adjusts the various parameters of LED 103 and 105; the parameters including: brightness, color, light emitting frequency, luminous intensity, duration, and etc. LED driver 206 may be fabricated on the flexible printed circuit board (FPC), in order to match the shape of array of LEDs which are arranged on the cambered shape of the wearable device 200.

A sensor 207 may be used for sensing the user's body movements when the user operates the smart wearable device, so as to generate a control signal for controlling the wearable device. The sensor 207 can be, for example, a motion sensor to determine the motion of the wearable device 200; a gravity sensor to determine the acceleration of the wearable device 200; an angular velocity sensor (gyro) to determine the orientation of the wearable device 200; a light sensor to determine the intensity of the light external to the wearable device 200; a proximity sensor to sense the object near to the wearable device 200, e.g., to sense if there are some objects or human beings are approaching the wearable device 200; etc.

Sensor 207, according to one embodiment, is a gravity sensor or acceleration sensor for sensing the acceleration signals generated when a user taps the wearable device 200, thereby triggering a specific function of the wearable device 200. For example, when a user taps the wearable device 200 worn on the wrist with certain intensity, the wearable device 200 will feel the force, resulting in an accelerated motion. When the intensity of the acceleration signal reaches a certain threshold, the wearable device 200 triggers the power-on function of LEDs, thereby to achieve a function of tap-triggered LEDs. Alternatively, it is also possible to trigger the power-on function of wireless module 204 to get ready to receive the control instructions from mobile terminal 230. Alternatively, the signal of triggering can be the shaking of the wearable device 200.

### Pairing the Mobile Terminals and the Wearable Devices

A user may pair a wearable device with a mobile terminal at first when he needs to set the functions of the wearable device by the mobile terminal. Such pairing is achieved by wirelessly connecting the wireless module of the wearable device and the corresponding wireless module of the mobile terminal. The wireless module of the wearable device can be powered-on by pressing a switch or by sensing the user's body movement by the sensor. For example, when a user taps the wearable device 200 worn on the wrist with certain intensity, the wearable device 200 will made an accelerated motion. When the intensity of the acceleration signal reaches a certain threshold, the wearable device 200 triggers the power-on function of the wireless module. Accordingly, the user also needs to turn on the corresponding wireless module of the mobile terminal. For example, when the wearable device includes a Bluetooth module as the wireless module, the user needs to turn on a Bluetooth module on the mobile terminal.

After turning on wireless communication between the wearable device and the mobile terminal, the wearable device can be controlled by the mobile terminal via its interface applications such as an app or via web interface by the way of a wireless communication. The interface application can send a signal to search a wearable device which has the corresponding wireless function power-on, when the interface application finds the responding wearable device, it will establish the wireless communication. When wireless communication is established, the LEDs on the wearable device can be set to emit a specific color or flash for a certain time to show the success of establishing wireless communication. An interface application on the mobile terminal may also send the information to the user to show the success of establishing wireless communication.

### The Set of Basic Functions

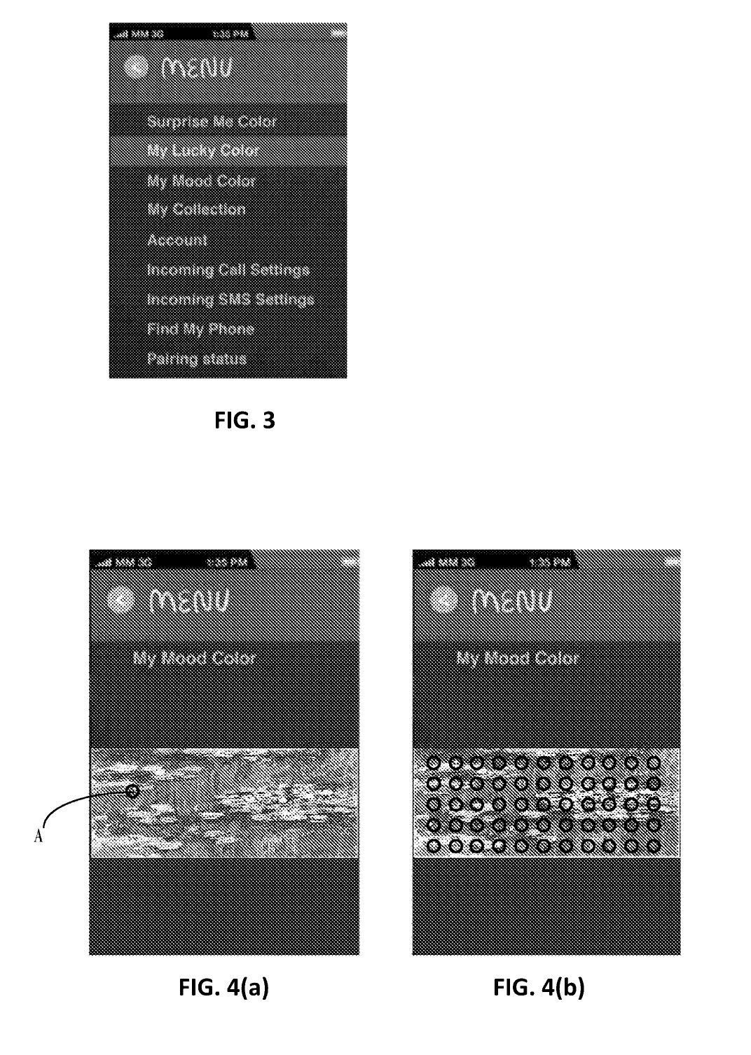

FIG. 3 schematically shows an exemplary graphical user interface of an interface application on a mobile terminal. As shown in FIG. 3, the user can set various parameters of the LEDs through the interface application on the mobile terminal, said parameters include: color, light intensity, emission time, blinking frequency and so on. When the user sets a particular display color or combination of colors through the interface application, the mobile terminal will send corresponding control instructions to a corresponding wearable device. When the wireless module of the wearable device receives such instructions the central control module of the wearable device generates corresponding drive control signals and sends them to LED driver, thereby driving the LEDs to emit light of color or color combination corresponding to the instructions.

Users can also set user's basic information in the mobile terminal, such as account information, passwords, email addresses, phone book information, account information of associated social networking, sex, date of birth, etc. The interface application can gather such basic information and automatically generate some specific control instructions to control the LEDs to emit a particular color or combination of colors. For example, when the system time is detected to match the birthday information entered by the user, a specific instruction can be sent to the LEDs to display a special color or combination of colors.

According to an embodiment, a user can set the user's account in the mobile terminal and associate the account with some social network accounts, such as Weibo, WeChat, Facebook, Twitter, etc., when a particular behavior occurs on such social networks, it can be fed back to the interface application of a mobile terminal. Then the mobile terminal can be triggered to generate a specific instruction to drive the LEDs on the wearable device to display a particular arrangement of light. For example, when a user on a social networking site released a new message, and receives a “Like” from another person, such behavior can be fed back to the mobile terminal to send an instruction to the wearable devices. When the wearable device receives such an instruction, it generates a driving signal for driving the LEDs to display a “red heart” pattern. For example, such pattern may be flashing or displayed for some time. Therefore, the users need not frequently check their social media accounts and they can know about other users' feedback, thereby achieving convenient and flexible interactions.

According to another embodiment, after the user associates his account of a social network, his behavior on social networks can be used for data mining and data analysis to extract the features of user's mood and preferences, etc., thereby triggering control instructions to the LEDs of the wearable device to display an associated pattern. For example, when the user releases a text or picture message including the “good mood” and other words on the social networks, the interface applications of a mobile terminal can collect the keywords such as “mood”, “good”, or “good mood” and analyze according to keywords or keyword combinations to determine the user's emotional state at this time. For example, when the user is in a good mood, the LEDs of the wearable device can be triggered to display warm colors and patterns to reflect the user's mood.

According to another embodiment, the interface application of the mobile terminal can also include or associate with other types of applications to trigger corresponding control instructions to the LEDs of the wearable device to display associated pattern of information. For example, the interface application of the mobile terminal can associate with a weather forecast service application, and thereby display the weather conditions on the LEDs in a specific combination of color or pattern. For example, it can display a yellow sun pattern to show the sunny weather, a blue cloud pattern to show the cloudy weather, a gray patch pattern to show the fog and haze weather, a green drops pattern to show a rainy weather, etc.

### Reminder Functions

Users can also set reminder functions in the interface applications, such as phone call reminder, short message reminder, e-mail reminder or instant message reminder and so on, such that the LEDs of the wearable device can be triggered to display corresponding color as the reminders. For example, the user can set the blue color for 30 seconds as the reminder of the phone call from a particular number, when the phone call from that number is received, the interface application will be triggered to send a control instruction to the wearable device via the wireless communication, and central control module of the wearable device will generate the corresponding control signals to drive the LEDs to emit blue light for 30 seconds.

According to an embodiment, the user can also trigger a control instruction by the wearable device. For example, when the user shakes the wearable device with a certain intensity and frequency, the wearable device can be triggered to generate a corresponding control signal, which can be sent back to the mobile terminal to trigger further instructions. For example, the user can set the wearable device to be triggered to make the LEDs display the time by shaking it two times. Such time displaying can be achieved by the controller chip on the wearable device which is integrated with the time function.

For example, a user can set a ring tone in the mobile terminal as the searching reminder, and such reminder can be triggered by continuous shaking the wearable device three times, thereby reminding the user the location of the mobile terminal, so as to achieve a so-called function of seeking the phones by the wearable devices. Specifically, when the sensor of the wearable devices senses a particular action by the user, such as continuous shaking the wearable device three times in a certain acceleration, it will trigger the wearable device to send instructions to the mobile terminal via the wireless module, and then the mobile terminal will be triggered to play the ring tone set by the user, thereby achieving the purpose of seeking and positioning.

### Color Extraction Function

According to an embodiment, the interface application of the mobile terminal can not only provide users with some fixed colors to be selected for setting the color displayed by the LEDs of the wearable devices. The interface application can also provide users with colors extracted from pictures uploaded by the users. The interface application can extract color of a particular spot in pictures uploaded by the users and simulate the LEDs on the pictures, thereby control the LEDs to display corresponding colors of the pictures.

FIGS. 4(a)-(b) shows an example of extracting the colors on pictures supplied by the user and displaying corresponding colors on LEDs. Wherein FIG. 4(a) shows an example of extracting the color of a single point selected from the picture which is uploaded to the mobile terminal by the user; FIG. 4(b) shows an example wherein the user selected an entire picture, the interface application simulated the location of each LED corresponding to the picture and extracted the colors of a plurality of corresponding locations and displayed those colors on LEDs at corresponding locations. When the user selects a color which is a color mixed by a variety of colors, this mixed color can be simulated as a closest single color and be displayed on a LED of the wearable device.

As shown in FIG. 4(a), when the user selects a color of spot A on a picture and hopes this color can be correspondingly displayed by an LED of the wearable device, a color may be extracted by the algorithm of image mosaic. That is, to fill a square of a certain range with the color value of a pixel within the square. Specifically, when the point A selected by the user contains m×n pixels (i.e., contains m×n color values), those color values of pixels should be transformed to one color value which is to be displayed by the LED. The transformation of color values can be achieved by one or more of the following methods:

Method 1: Directly select the color value of anyone of m×n pixels contained in the point A, for example, the RGB value of pixel (1,1), pixel (m,n), or pixel (m/2, n/2) can be chosen.

Method 2: Average processing of all values of all m×n pixels, e.g., each pixel consists of three components of R, G, and B, the average of R, G, and B components of all m×n pixels, respectively, can be calculated and used as the final R, G, and B values.

Method 3: Weighted average or convolution processing of all values of all m×n pixels. The weight or convolution operators can be set in need. For example, the weight is lower for the pixels near the edge, and it is higher for the pixels near the center.

When a color value of a selected point A is determined, the mobile terminal may send instructions in encoded form to the wearable device for displaying the color of determined color values.

As shown in FIG. 4(b), when a user selects an entire picture and hopes to display it correspondingly on the LEDs, the picture may be segmented. Specifically, the array of LEDs of the wearable device will be simulated on the selected picture in the same proportion, and then the color value of each spot will be extracted by the method as shown in FIG. 4(a). When color values of all selected points are determined, the mobile terminal may send instructions in encoded form to the wearable device to drive the LEDs to display the entire picture in a mosaic manner.

A smart wearable device with an adjustable sparse array of light-emitting array, by providing a plurality of adjustable LEDs, may enable users to wirelessly connect a bracelet or other wearable device to an intelligent terminal, and to adjust each light source or the entire light emitting display array by the intelligent terminal. In this way, the users can change the color of the light-emitting array and control the brightness of the light emitting arrays, etc., so that the user wearable bracelet can display personalized results. Additionally, the light-emitting array can also display status information of the intelligent terminals, such as important phone alerts, SMS tips and other functions, and to achieve the mobile location and mobile phone anti-lost functions via wireless pairing technology.

### Enhanced Functions

In some examples, a wearable device may be paired with a smart device such as a smart phone, tablet, personal computer, or the like. Such pairing may allow a user to configure a wearable device using their smart device, for example, by using software that is dedicated to such configuration and uses simple graphics and menus to make such configuration convenient and quick. For example, an app may be provided for download to a smart device which then allows the smart device to be paired with a wearable device. Once the devices are paired, a user can set preferences and configure a wearable device using a touchscreen, voice commands, or other input to the smart device. Examples of such configuration is shown in FIGS. 3-4 of the '323 application. In other examples, input may be provided directly to a wearable device.

In an example, a buyer of a wearable device receives website information (e.g. a Universal Resource Locator, or URL) that is associated with the wearable device. When they go to the website (e.g. using a web browser) they may receive information about configuring their wearable device, which may include instructions (e.g. instructional text, audio, and/or video). Such instructions may include details regarding obtaining and configuring an app to interface with the wearable device. For example, a user may be directed to the Apple App Store or to Google Play, or similar sites, where they can obtain an app to download to their smart device, for example, a device running iOS or Android operating system.

When a user installs an app, they may be asked to register with a wearable device maker. For example, an email address, phone number, or the like may be used as an identifier. Registration may also be done using a social media or email account. A user may then pair their smart device with their wearable device using an appropriate interface. For example, Bluetooth pairing of such devices may include configuring the wearable device to be discoverable and then searching for the wearable device using the app. The wearable device and smart device may be unpaired through the app also.

Once a wearable device and a smart device are paired, the app may allow a user to configure the wearable device by choosing from among a number of different options, for example, by scrolling through a menu, which may include graphics and/or text on a screen, through voice commands, or otherwise. Colors and/or patterns may be selected by a user from a menu or menus.

In some examples, a user may choose a pattern including one or more colors from one or more collections. For example, an individual user may create their own pattern by selecting from templates, using a touchscreen to draw a pattern, combining previous patterns, or otherwise. A geometric pattern may be created by adding or removing elements to be illuminated. Colors may be selected by color matching (e.g. matching with clothing), color extraction (e.g. from photo or artwork), manual selection, or otherwise. A pattern may be stored for future use and one or more patterns may form collections that are subsequently available to the user. In some cases, collections may be made available to multiple users (e.g. collections may be publicly available for download from the internet, or for download to individuals who meet certain criteria). Users may have their own collections based on their preferences and may designate such collections as private, public, or may limit access in some way (e.g. only providing access to friends). Such individual collections (e.g. individual collection designated as “my collection”) may be stored remotely (e.g. in the cloud) and/or locally (e.g. on smart device and/or wearable device).

Collections provide users with many different options to easily configure the appearance of a wearable device. Examples of functions that may be selected include, but are not limited to, the following:

“Sync with my collection” A particular pattern and/or color scheme from a collection may be selected for display on a wearable device by synching the device with the selection. An app may provide an interface for browsing collections and selecting a desired option for synching. Collections may be stored at any convenient location, locally or remotely (e.g. in the cloud).

“Surprise me” Users may obtain random patterns by selecting a “surprise me” option. This option may be selected using an app, directly on the wearable device, or otherwise. If the user likes the randomly selected pattern then the user may synch with the wearable device so that the pattern is displayed on the wearable device. If the user does not like the randomly selected pattern then the user can obtain another pattern. In some examples, a random pattern may be selected directly by the wearable device, using a paired smart device. For example, tapping or shaking a wearable device (or otherwise providing some predetermined input) may trigger selection of a random pattern to display on the wearable device.

Color matching/Color extraction A color extraction function may be provided as described in the '323 application so that colors and patterns displayed on wearable devices may reflect photos, drawings, artwork, or other input. The extraction may be performed remotely or locally. For example, a photo may be taken with a smart device and may be uploaded to a remote location for extraction. Alternatively, extraction may be performed by the smart device without transferring the photo elsewhere.

Some wearable devices include one or more cameras so that color matching may be performed within the wearable device, without requiring a separate smart device. For example, a camera on a wearable device may be directed to a particular item of clothing to capture the appearance of the item of clothing and the wearable device may then configure LEDs or other display devices according to the appearance of the item of clothing so that the appearance of the wearable device is aesthetically pleasing in combination with the item of clothing (e.g. matching color and/or pattern, complimentary color and/or pattern, contrasting color and/or pattern, etc. according to user's aesthetic preferences). While some wearable devices may have a sparse array of LEDs, some wearable devices may include a display with a resolution that allows it to substantially replicate a photo (i.e. a display may have enough pixels to provide an image that looks like the captured image to a user, e.g. about 300×300 pixels or more). Such a wearable device may display a photo that was taken by the wearable device, or may scroll through, or otherwise combine multiple photos. For example, family photos may be stored in such a wearable device and may be displayed as desired by a user. In some cases, a camera that is located within the wearable device may allow a wearable device to adapt in real-time to its environment, for example by adjusting brightness, color, pattern, and/or other parameters according to camera output.

### Customized Notification

Users can select important contacts from a contact list. When important contacts call or text message the user, a wearable device may vibrate, display a name, a symbol, photo, or other designator that the user has created for them, or some combination of designators. In some cases, visual display may be supplemented with a non-visual indicator such as sound or vibration. For example, a wearable device may include a vibration generating unit (e.g. electric vibrating motor) that can alert a user silently when they receive a call, text, or email from an important contact. Such customized alerts may inform a user of important communication without necessitating looking at a phone or other device.

### Flexible Structures

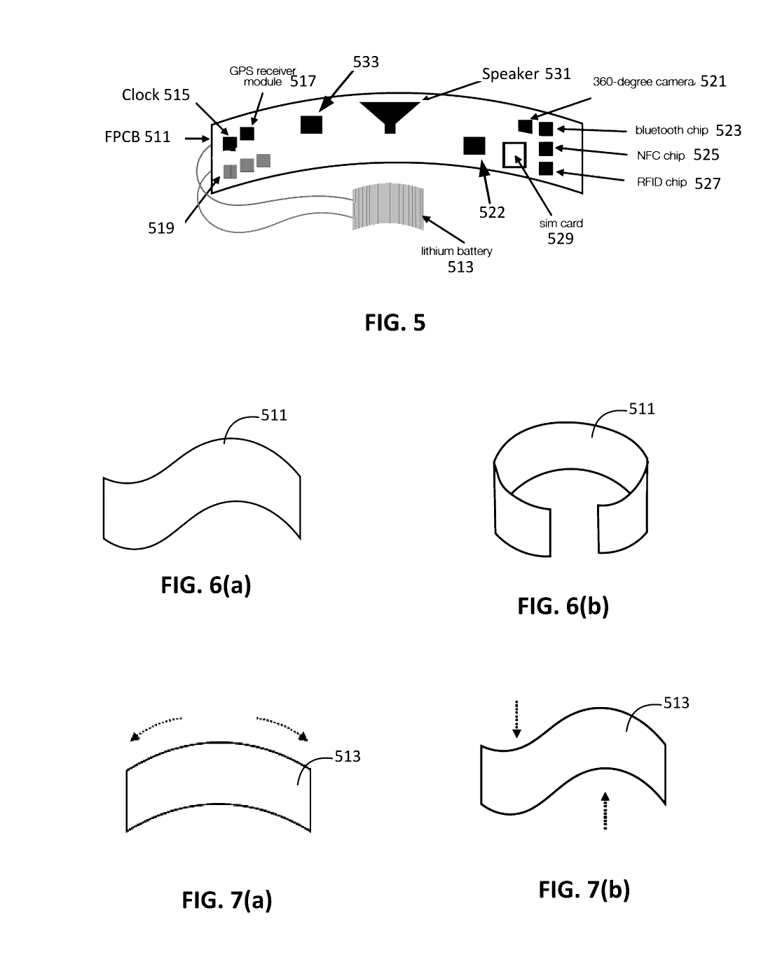

FIG. 5 shows an example of flexible structures that may be used in a smart wearable device (e.g. bracelet) or in other locations where flexibility may be desirable. The flexible structures shown in FIG. 5 form a flexible computing system, with many of the functions of rigid computing systems that are used in laptops, smart phones, tablets, and the like. While rigid components, such as conventional Printed Circuit Boards (PCBs) and batteries may be located in a curved housing to form a curved appearance, this does not efficiently use space and may result in a device that is unnecessarily bulky, has insufficient computing power, or battery time, or some combination. Using flexible components allows efficient use of space in a curved volume such as formed in a bracelet or the like. While flexible components may be protected from flexing forces by a rigid housing in a bracelet, in other cases flexible components may be exposed to flexing forces and may be free to flex during use. For example, a flexible computing system that is incorporated into clothing may have a flexible housing (e.g. plastic sheath to provide protection from water, dust, etc.) that leaves the flexible computing system free to bend when some bending force is applied. Such a flexible system may be less noticeable than a rigid system would be in some locations. For example, a flexible computing system that is located in or on a flexible panel of a garment, accessory, or sports article (e.g. in or on a panel of fabric, leather, or plastic that forms part of an article of clothing, shoe, bag, belt, etc.). This may allow a computing system to be inserted in spaces where a conventional system could not be inserted, or may allow a more powerful system (system with more computing power and/or more electrical power storage) to be inserted in a given location. Thus, a flexible computing system may provide significant advantages in certain applications.

The flexible computing system of FIG. 5 includes a flexible PCB 511 and a flexible lithium battery 513. Flexible PCB 511 in this example has various Integrated Circuits (ICs) mounted along one surface, while display elements (not shown) are mounted along an opposing surface. For example, in an article of jewelry (e.g. bracelet) the display elements may be along an outward facing side of the flexible PCB while other ICs that are not display elements may be along an inward facing side of the flexible PCB. Flexible PCB 511 includes a clock IC 515, Global Positioning System (GPS) receiver module 517, motion and speed ICs 519, camera/microphone module 521, Bluetooth IC 523, Near Field Communication (NFC) IC 525, Radio Frequency Identification (RFID) IC 527. It will be understood that these are merely examples of ICs (e.g. silicon chips, or dies) that may be mounted on a flexible PCB to form a flexible computing system. Additional ICs may include a controller, power control IC, other communication ICs, a display control IC, memory such as nonvolatile memory (e.g. flash) etc. ICs are interconnected through leads or traces formed as part of the flexible PCB.

In addition to the ICs mounted directly to flexible PCB 511, one or more interfaces may be formed to allow components to be removably connected to PCB 511. For example, a Subscriber Identity Module (SIM) card 529 is connected to PCB 511. SIM card 529 may be permanently attached to PCB 511 or may be connected through a physical interface that allows SIM cards to be changed by a user. For example, a standardized interface may include a slot with electrical pins in a standardized arrangement that allows any SIM card with a corresponding pattern of contacts to be inserted and used in the flexible computing system. Alternatively, a controller or other component may store an electronic SIM, or eSIM, without dedicated components such as a slot and card.

Motion and speed ICs 519 may include one or more gyroscope sensors, magnetic field sensors, accelerometer sensors, and/or other sensors. These sensors may be arranged to provide outputs that reflect the motion of an article such as a bracelet as a single unit, or may be arranged to provide outputs that reflect different motion of different portions of an article so that different speeds and accelerations of different portions of the article are available. For example, sporting articles such as golf clubs may have sensors at different locations to capture motion that may be very different at the different locations.

Camera module 521 is shown as a single unit but it will be understood that multiple cameras may be used. A camera may be a single camera that is mounted so that it captures a particular view. For example, where a flexible computing system is located in a garment, the view may be similar to the view seen by the wearer of the garment. In an example, a flexible computing system located in a collar or belt may include a camera that is directed ahead of the user so that it captures the user's field of view.

A microphone 522 may capture the sounds heard by the user. Such a camera with microphone (camera 521 and microphone 522) may be useful for law-enforcement officers and other individuals that may later need a record of their activities. In other embodiments, a camera and microphone may be combined in a single unit so that they are mounted together and point in the same direction. It will be understood that additional circuits may be provided in connection with various components shown and that all related circuits may not be shown. For example, camera 521 and microphone 522 may be connected to various related circuits (e.g. drivers) on other chips that are not shown.

SIM card 529 may be a suitable SIM card that allows a flexible computing device to connect to a wireless network (e.g. a commercial cellular telephone network). While examples above describe communication between a smart wearable device such as a bracelet and a smart phone, in some cases, a smart phone is not needed. For example, where a flexible computing device includes a SIM card, the flexible computing device may communicate through a cellular network with other computers including internet servers and with other internet enabled devices e.g. with smart TVs, smart appliances, internet-of-things (IoT) components, and directly with other flexible computing devices. Pairing of such flexible computing devices may not be necessary. In some cases, pairing may allow faster, or more secure communication so that both alternatives may be desirable. Direct communication through a cellular network, without using a smart phone or tablet may be desirable for some applications.

Speaker 531 provides an audio output. For example, such audio output may be used to play music, speech, or other output that a user may want to listen to. In combination with a microphone, such as microphone 522, speaker 531 may be used for two-way audio communication. Speaker 531 may also provide audible alarms and indicators. For example, a user may set a timer with an alarm, or may have an alarm set to go off when a certain condition occurs. Alarms, tones, or other audible indicators may indicate the arrival of a text message, phone call, email, or other communication. It will be understood that additional circuits may be provided in connection with speaker 531, for example, a driver circuit on one or more driver chip. Two or more speakers may be provided in some cases.

Vibrator unit 533 generates vibration that a user may feel when in contact (direct or indirect) with a flexible computing system. For example, a haptic vibrator may produce mechanical vibration of sufficient strength to be notice by a user. Such vibrators are well known components of cell phones and the like and allow a user to be alerted to various conditions without other people being aware. In some cases, a user may choose whether to receive alerts, and in which format to receive any alerts. For example, a menu may provide a user with the option of a quiet mode in which speaker 531 is disabled and in which any alerts are provided by vibrator unit 533. In some cases, selection of alerts may be determined automatically, for example, based on the time of day, so that at night no alerts are provided and at certain quiet times only vibrational alerts are sent. Other configurations may also be used.

Near Field Communication (NFC) IC 525, Radio Frequency Identification (RFID) IC 527, and/or other communication devices in a flexible computing system may allow a user to access various services efficiently. For example, such devices may allow electronic payment through an appropriate payment terminal. Thus, a user wearing an article of jewelry or a garment that contains a flexible computing device may pay using the article of jewelry or garment, without having to produce a card, cash, or otherwise access any articles that are only useful for payment. Approval for payment may be given by a tap detected by a sensor, a sound detected by a microphone (e.g. verbal utterance “approved”), by a visual indicator detected by a camera, by a positional indicator detected by any suitable device, or otherwise. Payment for public transit may also be made in this way. Thus, a flexible computing system may operate as a fare card that allows a user to enter a turnstile without having to find a card or cash. Payment for a ride-sharing service or Transport Network Company (TNC) may also be made in this way through a SIM card when a GPS IC is provided. Thus, a user may get a ride from such a service (e.g. Uber, or Lyft) without a smartphone and without using a credit card or cash as with a conventional taxi. In some cases, an electronic lock may be opened using NFC, RFID or other communication system. For example, a door or gate may open when a user approaches wearing or carrying a flexible computing system. In some cases, additional verification may be desirable so that as a user approaches a door or gate, the hardware connected to the lock may identify the person from NFC or RFID, or the like and may then text, or call the person to confirm their identity.

Flexible Lithium battery 513 is connected to flexible PCB 511 via electrical wires. In some cases, such wires may be fairly long so that a battery may be located remotely from a PCB. In other cases, leads may be short, or a battery may be directly connected to a PCB to provide an efficient connection. For example, in a bracelet, short leads may be used if a battery is to be located close to a PCB. In some cases, more than one battery may be connected to a flexible PCB so that the flexible computing system may remain powered up for a long time. In some cases, multiple flexible PCBs may be connected to a single battery. A battery to PCB connection may be permanent or may include a connector that allows batteries to be swapped (e.g. a discharged battery may be replaced with a charged battery). A charging circuit may be mounted on a flexible PCB or elsewhere to allow a battery to be recharged in-situ.

FIG. 6(a) illustrates flexibility of a flexible PCB 511. A flexible PCB may be formed of any suitable materials so that the PCB may be deformed from a planar shape into a range of curved shapes without affecting its functionality (i.e. without breaking electrical connections or otherwise significantly affecting electrical characteristics) thereby allowing it to fit and operate in spaces where a planar PCB would not fit. FIG. 6(b) shows another example of a flexible PCB that is rolled into a semi-circle. Such a shape may be suitable for a location in a bracelet or other curved object. In other examples, a flexible PCB may be rolled into a complete circle (360 degrees) or more. For example, a flexible PCB may be rolled up so that it becomes cylindrical in shape, which may be desirable for certain locations. In general, components may be designed to allow them to be bent to fit in a given location. Thus the radius of curvature for a PCB, battery, or other component in a bracelet may be larger than the radius of curvature in a different location.

FIGS. 7(a) and 7(b) illustrate flexibility of flexible battery 513 with arrows showing forces that deform flexible battery 513 in different ways (i.e. into a crescent shape in FIG. 7(a) and into an S-shape in FIG. 7(b)). While some batteries may be damaged by being deformed, flexible battery 513 is self-healing. Thus, even if flexible battery 513 is initially affected by bending beyond a limit, it is somewhat elastic and recovers when it returns to its initial shape, or returns to within the limit (e.g. limit may be a radius of curvature beyond which the battery is affected). A flexible battery may be a lithium battery or other suitable battery.

While an article of jewelry such as a bracelet is one example of where a flexible computing system may be used, there are many other locations where a flexible computing system may be used. For example, a flexible computing system may be located in an accessory that is worn on the body (e.g. a belt), or is carried (e.g. bag, such as a handbag, brief case, backpack, etc.).

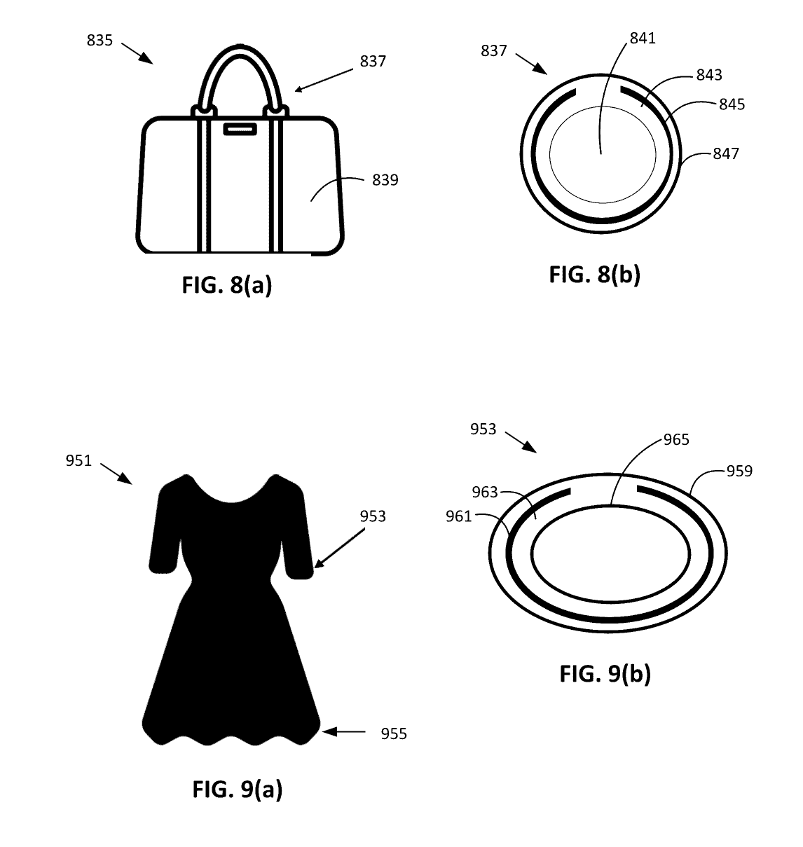

FIG. 8(a) shows an example of a bag 835 that includes a flexible computing system. The flexible computing system may be rolled up so that it fits in a handle 837 or other component that is relatively stiff. Alternatively, a flexible computing system may be positioned along a surface of a panel 839 that forms part of the bag. For example, between an outer panel and a lining. In an example, one or more outer panels of such a bag may be display panels that can be controlled by a flexible computing system so that the appearance of the bag may be changed to display different colors and patterns. In one example, the color and/or pattern of the bag is matched to an image, for example, an image obtained by photographing a pair of shoes so that the bag matches the shoes. A camera may be provided in the bag for this purpose. Alternatively, a different device may be used (e.g. smartphone, tablet, etc.). In another example, outer panels of both shoes and a bag are configurable and may both be controlled to match a garment such as a dress or jacket.

FIG. 8(b) shows a cross sectional view of handle 837. A handle core 841 is the main structural component and may be made of a suitable low-stretch material with a high tensile strength. Flexible battery 843 extends about handle core 841 and flexible PCB 845 extends about flexible battery 843. In the example shown, these components wrap around handle core 841 and partially encircle handle core 841. In other examples, one or more component may complete more than a full turn around a handle core (e.g. wrap twice around a handle core) thereby encircling the core more than once. An outer layer 847 provides environmental protection for the flexible computing system formed by flexible battery 843 and flexible PCB 845. Outer layer 847 may be made of a material chosen for its aesthetic benefits (e.g. leather) as well as its protective characteristics. Carrying a bag with a flexible computing system may enable a user to pay for goods and services, pay for transport, open locks, and perform other functions described above, without using a smart phone or other hardware.

FIG. 9(a) illustrates an example of a flexible computing device located in a garment, in this example, a dress 951. A flexible computing device may be integrated into a garment at any suitable location, for example, at a cuff 953 or a hem 955. A garment that includes a flexible computing system may enable a user to pay for goods and services, pay for transport, open locks, and perform other functions described above, without using a smart phone or other hardware. Garments such as dress 951 may also include one or more sensors to monitor a wearer and allow health data to be gathered and analyzed. For example, heart rate, temperature, blood pressure and the like may be monitored and recorded and may be analyzed to monitor health and fitness.

FIG. 9(b) shows a cross section of sleeve or cuff 953 including an outer layer 959, which may be a fabric layer that forms part of the dress and may provide some protection for internal components. Inside outer layer 959, a flexible PCB 961 and a flexible battery 963 are arranged so that they curve around and allow the shape of the sleeve to be unaffected by the flexible computing system. An inner layer 965 extends inside flexible battery 963 to provide protection to the components of the flexible computing system. Additional protective layers may be provided as appropriate.

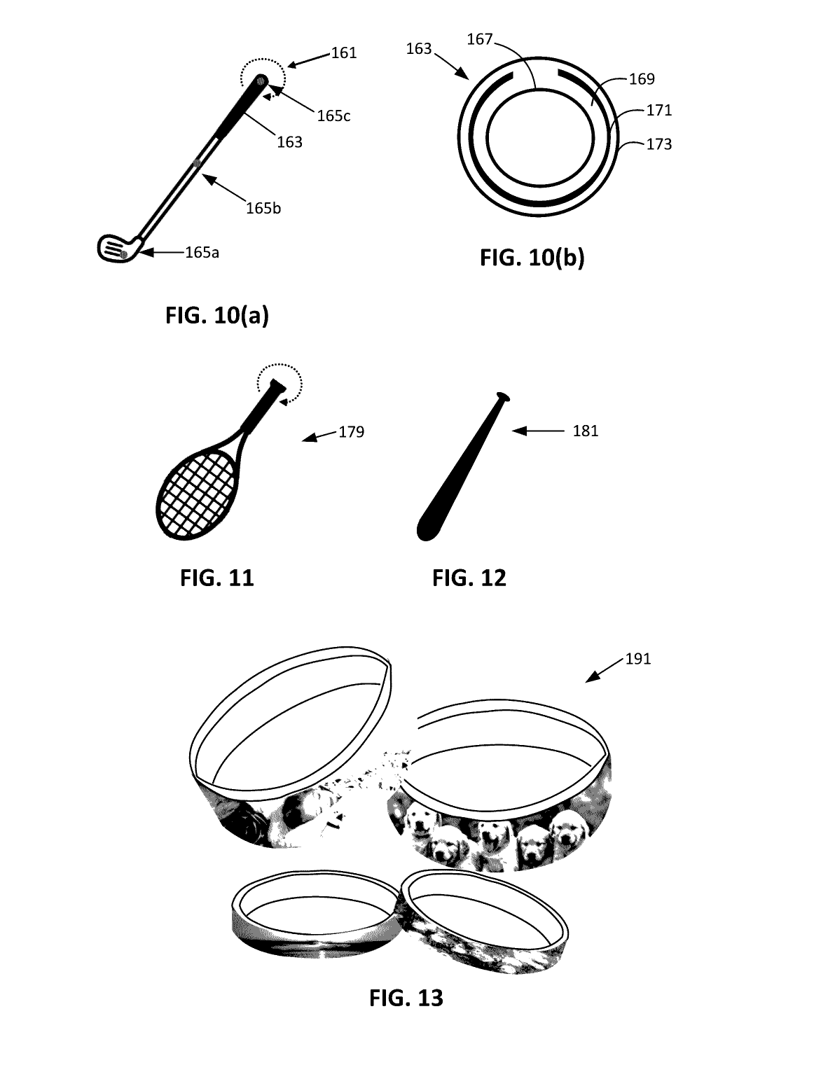

FIG. 10(a) illustrates a golf club 161 that includes a flexible computing device that is wrapped around the golf club shaft 163. In addition to the flexible computing device, golf club 161 includes multiple sensors, in this example, three sensors 165a-c. Sensors 165a-c may include position sensors that allow position tracking during a golf swing so that a golfer can later analyze their swing and learn how to improve. In some cases, such a smart golf club may be used with a smart garment (e.g. golf shirt and/or pants) and/or accessory (e.g. belt and/or shoes) that also include sensing hardware so that additional information is recorded regarding the golfers motion when swinging. In this way, a complete 3-D recording of the golfer's body and the golf club may be obtained for a golfer's swing and any problems may be identified and corrected.

FIG. 10(b) shows a cross sectional view of golf club shaft 163 including a core 167 (e.g. a cylindrical metal shaft. A flexible battery 169 and flexible PCB 171 are wrapped around core 167. An outer layer 173 provides protection and may be formed of a suitable material to provide a good grip for playing golf. In other examples, instead of wrapping a flexible PCB around a flexible battery, these components may be wrapped around different portions of a shaft so that the added thickness is reduced.

Flexible computing systems may have applications in monitoring various sporting activities. Flexible computing systems may be incorporated into various sporting apparel and various items of sporting equipment for this purpose. For example, FIG. 11 shows a tennis racquet 179 that includes a flexible computing system wrapped around its handle in a manner that is similar to golf club 161. Multiple sensors may be incorporated into tennis racquet 179 to monitor movement and provide feedback to a player.

FIG. 12 shows an example of a baseball bat 181 that includes a flexible computing device and sensors. It will be understood that in any of the above examples, a flexible computing device and sensors may be built into an article of sporting equipment or may be added after manufacture and may be provided as a kit for example so that an owner can upgrade their equipment and make it “smart” at least temporarily.

It will be understood that a range of smart sporting goods may incorporate flexible computing devices including, not only the examples above but also various other articles where some form of positional or other information may be useful. For example, skis, helmets, pads, balls, pucks, paddles, sails, bicycle frames, and other items may include sensors that provide useful information.

While some examples above are directed to sparse LED displays, in other examples higher resolution screens may be used. For example an Organic LED (OLED) display may be used instead of a sparse LED display so that a drawing or photograph can be reproduced on a surface.

FIG. 13 shows an example in which bracelets 191 include high resolution displays as outward facing surfaces that are controlled by flexible computing devices housed in the bracelets. Such a display may show family photos, news photos, favorite scenes, etc. and may be configured using a smart phone, tablet, or directly, for example by tapping or through voice commands. In some examples, displays may be touchscreens that allow a user to input instructions through the display. In addition to configuring the look of such a bracelet, a user may configure the texture by applying an appropriate cover layer. For example, a canvas look and feel may be achieved by applying a cover with a textured surface that simulates canvas.

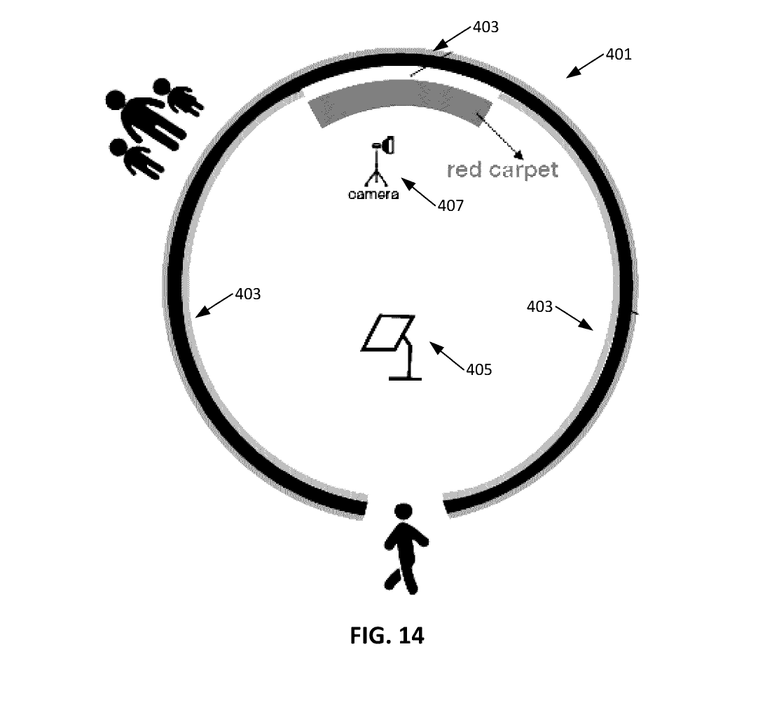

FIG. 14 shows an example of a kiosk 401 that may interact with a smart device including a smart wearable device or other smart device described above. Such a kiosk may be placed in a high-traffic area of an airport, shopping mall, theme park, in a store, or the like. A person with appropriate hardware that is enabled may be recognized when they are close to the kiosk e.g. using NFC, RFID or other identifier. The person may then be greeted using an audible message (or may be sent a greeting in some other form such as a text). The person then enters the kiosk and sees the display 403 along the inner wall of the kiosk. Displayed material may be specific to the location (e.g. showing arrival/departure times in an airport, promotional events in a mall, or lyrics in a karaoke bar). Displayed material may be controlled by a tablet 405 that is located in the kiosk. Displayed material may be customized to a particular person when they are identified from a flexible computing system that they are wearing or carrying (e.g. using SIM or other identifier). A red carpet area is provided where a user can use a camera 407 to take a photo of themselves (a “selfie”) with a selected background and can post it to social media. The walls of kiosk 401 are curved and may be formed in panels that are adapted for rapid assembly. For example, wall panels may be bolted together, or snapped together so that the kiosk can be easily moved from one location to another. The kiosk may be of any size with different sized kiosks used in different locations.

Those skilled in the art can appreciate, based on the above disclosure, a variety of modifications and variations are possible. Certain portions of the specification described embodiments in terms of algorithms and symbolic representations. These algorithmic descriptions and representations are commonly-used by the skilled person in the art of data processing for effectively communicating their work to other persons. It should be understood that those operations described in the functions, calculations or logics could be achieved by computer programs, equivalent circuits, or microcode or the like. In addition, it has been repeatedly demonstrated that these actions could be conveniently arranged as the modules, without loss of generality. The operations and associated modules described may be implemented as software, firmware, hardware, or any combination thereof. By reference to the embodiments disclosed herein and the practice, other embodiments are apparent to those of ordinary skill in the art. The specification and examples should be considered as exemplary only, with a true scope and spirit of the invention defined by the claims.

### CONCLUSION

Although the various aspects of the present invention have been described with respect to exemplary embodiments thereof, it will be understood that the present invention is entitled to protection within the full scope of the appended claims. Furthermore, although the present invention teaches the method for implementation with respect to particular prior art structures, it will be understood that the present invention is entitled to protection when implemented in memory arrays with architectures than those described.

1. A smart wearable device comprising:
a housing having a physical shape and size adapted for wearing on a human body, the housing comprising a first portion for attaching to the human body and a second portion exposed to the outside of the human body;
a sparse light-emitting array comprising a plurality of spaced light-emitting sources, the light-emitting sources arranged on the second portion;
a control circuit including a wireless module, the control circuit configured to control lighting of the sparse light-emitting array in response to external control signals that are received wirelessly; and
at least one electrical contact arranged on the housing, the at least one electrical contact configured to provide at least one of: electrical power to the smart wearable device or data transfer between the smart wearable device and an external device.

2. The wearable device as claimed in claim 1, wherein the wearable device further comprises a sensor arranged inside the housing for sensing the user's body movements when the user operates the smart wearable device, so as to generate a control signal for controlling the wearable device.

3. The wearable device as claimed in claim 1, wherein an individual light-emitting source is a Light Emitting Diode (LED).

4. The wearable device as claimed in claim 3, wherein adjacent light-emitting sources in the sparse light-emitting array are spaced apart by a distance in a range of 2 mm-4 mm, the shape of the light-emitting sources is circular shaped, and the diameter thereof is 0.7 mm-1.2 mm.

5. The wearable device as claimed in claim 1, wherein the wireless module is at least one selected from a group of Wi-Fi wireless module, WiMAX module, WAPI module, Bluetooth module, NFC module, infrared module, ultrasonic module, Wireless USB module and RFID module.

6. The wearable device as claimed in claim 1, wherein the wearable device is a wearable bracelet comprising an outer layer provided with the sparse light-emitting array and the outer layer is of resin material.

7. A flexible computing device comprising:
a flexible Printed Circuit Board (PCB);
a flexible battery connected to the flexible PCB, the flexible battery configured to provide electrical power to the flexible PCB;
a plurality of Integrated Circuit (IC) chips mounted on the flexible PCB, the plurality of IC chips including at least a controller chip, a motion sensor chip, and a communication chip; and
a display connected to the flexible PCB, the display configured to be controlled by the controller chip in response to an input from at least one of the motion sensor chip and/or the communication chip.

8. The flexible computing device of claim 7 further comprising a curved inner housing component that encircles or substantially encircles an opening, the flexible battery and the flexible PCB extending around the curved housing component, and the display extending around the flexible battery and the flexible PCB to form an outer housing component.

9. The flexible computing device of claim 7 wherein the plurality of IC chips further includes a GPS receiver chip connected to the controller chip.

10. The flexible computing device of claim 7 further comprising a Subscriber Identification Module (SIM) card slot mounted on the flexible PCB, the SIM card slot configured to accept a SIM card identifying a user of the flexible computing device on a cellular network.

11. The flexible computing device of claim 7 wherein the display is an LED matrix display or an OLED display.

12. The flexible computing device of claim 7 further comprising a camera connected to the controller chip, the controller chip configured to control the display in response to an input from the camera.

13. The flexible computing device of claim 7 wherein the communication chip is: a Wi-Fi wireless chip, WiMAX chip, Bluetooth chip, NFC chip, infrared chip, ultrasonic chip, Wireless USB chip, or RFID chip.

14. The flexible computing device of claim 7 wherein the flexible computing device is embodied in a sporting article and comprises additional motion sensor chips disposed at different locations in the sporting article, each of the additional motion sensor chips providing input to the controller chip.

15. The flexible computing device of claim 7 wherein the communication chip is a NFC chip or an RFID chip that is configured for communication with an electronic payment terminal or a lock.

16. A method of operating a wearable electronic device comprising:
storing a plurality of wearable device configurations, each configuration including a pattern of illumination of illuminating elements of a wearable device; and
providing an interface for selection of an individual wearable device configuration from the plurality of wearable device configurations by a user.
